(19) United States
(12) Patent Application Publication
(10) Pub. No.: US 2016/0092969 A1
(43) Pub. Date: Mar. 31, 2016

(54) METHODS AND SYSTEMS FOR IN-STORE FULFILLMENT PRIORITIZATION BASED ON CUSTOMER LOCATION

(71) Applicant: Wal-Mart Stores, Inc., Bentonville, AR (US)

(72) Inventors: Srikannan Gopalsamy, Foster City, CA (US); Vasu Palanisamy, Union City, CA (US); Chandrasekar Ramalingam, Union City, CA (US); Shanmuga Sundaram Sowndara Rajan, Fremont, CA (US); Dharani Prasad Pannam, Foster City, CA (US)

(21) Appl. No.: 14/501,789

(22) Filed: Sep. 30, 2014

(51) Int. Cl. G06Q 30/06; G06Q 10/08

(52) U.S. Cl. CPC G06Q 30/0635; G06Q 10/0836

(57) ABSTRACT

Various examples of methods and systems for in-store fulfillment prioritization based on customer location are described. In one implementation, a method may receive a first order from a first customer for in-store pickup of a first item by the first customer at a store. The first item may include a product or a service. The method may also determine a location of the first customer. The method may further prioritize fulfillment of a plurality of orders for in-store pickup based at least in part on the location of the first customer. The plurality of orders may include the first order and at least a second order for in-store pickup of a second item. The method may additionally execute a human resources logistics algorithm to predict the number of store associates required in order to service the plural orders in view of changes to the orders.

### TECHNICAL FIELD

The present disclosure relates to methods and systems for in-store fulfillment prioritization.

### BACKGROUND

In general, order fulfillment may refer to a complete process from point-of-sales inquiry to delivery of a product to a customer. In the context of a physical store, in-store fulfillment may refer to a process from receiving a customer notification, e.g., check-in for store pick of a product or service received via the Internet, to delivery of the product or service to the customer. This process may require a number of tasks including, for example, locating the product in the store's inventory, moving the product to the point of sales of the store, and staffing to ensure there is manpower to consummate the sale when the customer arrives at the store. When there are numerous fulfillment demands, however, fulfilling such orders efficiently presents a challenge. Moreover, with possibilities of new orders being added and existing orders canceled, it is also a challenge to ensure sufficient manpower to service the dynamically changing fulfillment demands.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting a computing environment within which example embodiments of in-store fulfillment prioritization of the present disclosure may be implemented.

FIG. 2 is a block diagram depicting an embodiment of an apparatus configured to implement example embodiments of in-store fulfillment prioritization of the present disclosure.

FIG. 3 is a flowchart diagram of an embodiment of a process related to in-store fulfillment prioritization in accordance with an embodiment of the present disclosure.

FIG. 4 is a flowchart diagram of an embodiment of a process related to in-store fulfillment prioritization in accordance with another embodiment of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

The articles “a” and “an” are used herein to refer to one or to more than one (i.e. to at least one) of the grammatical object of the article. By way of example, “a user” means one user or more than one users. Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or non-transitory computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

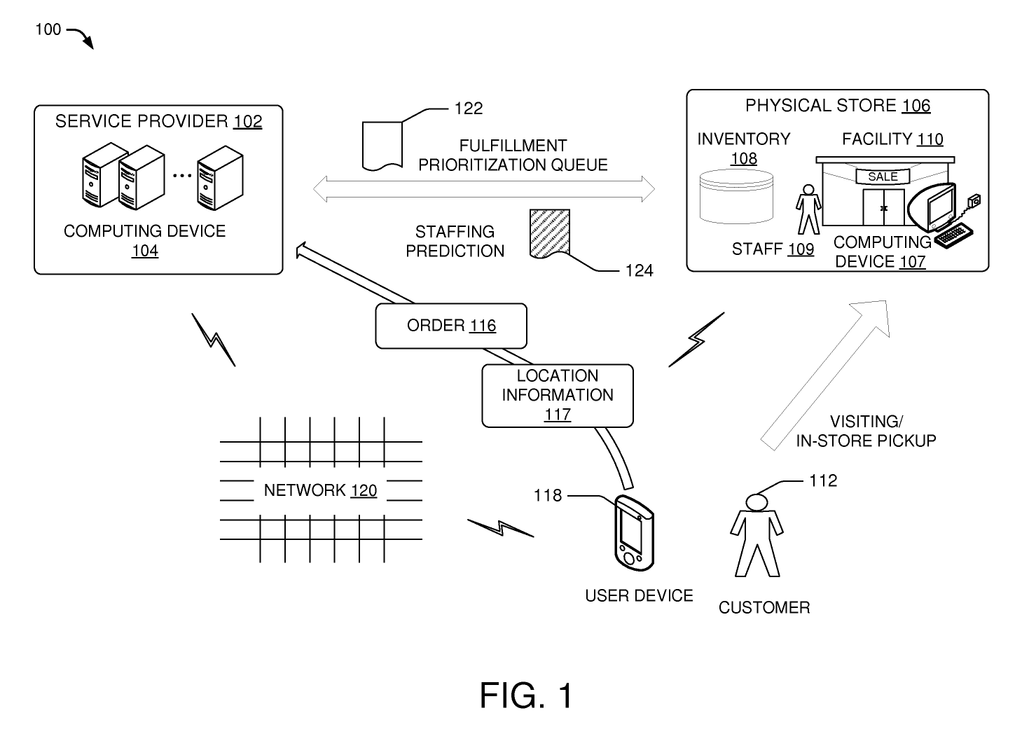

FIG. 1 is a block diagram depicting a computing environment 100 within which an example embodiment of the present disclosure may be implemented. Computing environment 100 includes a computing device 104, e.g., server, associated with a service provider 102. Service provider 102 may provide a service related to order fulfillment for one or more consumers, such as in-store fulfillment for a physical store 106. For example, the service may include a set of related software and/or hardware functionalities that, together with certain policies set by service provider 102, enable the physical store 106 to manage an inventory 108 and staff 109 associated with a facility 110 of the physical store 106 in prioritizing in-store fulfillment demands.

In some embodiments, computing device 104 may receive an order 116 from a first customer, such as user device 118 used by customer 112, for in-store pickup of a first item by customer 112 at a store, such as physical store 106. For example, customer 112 may install and execute a software application on user device 118, which may be a smartphone for example, and place order 116 via such software application. The software application may be provided by service provider 102. The first item may include one or more products and/or one or more services. Order 116 may or may not indicate a planned arrival time of customer 112.

Computing device 104 may also receive location information 117 from user device 118 of customer 112. Location information 117 may indicate geographic location of user device 118 in the form of, for example, global positioning system (GPS) coordinates or a street address. Based on location information 117, computing device 104 may determine a location of customer 112. Computing device 104 may also receive one or more other orders from one or more other customers (not shown) for in-store pickup at store 106. In other words, there may be plural orders received by computing device 104 for in-store pickup at store 106, including order 116 from customer 112 and at least one other order from another customer. Computing device 106 may prioritize fulfillment of the plural orders for in-store pickup based at least in part on the location of customer 112.

In some embodiments, computing device 104 may receive data and/or information related to customer 112 from user device 118 via a network 120. Network 120 enables computing device 104 to exchange information with user device 118. Network 120 may include wired and/or wireless networks that enable communications between the various computing devices described in environment 100. In some embodiments, network 120 may include local area networks (LANs), wide area networks (WAN), mobile telephone networks (MTNs), and other types of networks, possibly used in conjunction with one another, to facilitate communication between the various computing devices (e.g., computing device 104 and user device 118). User device 118 may be a mobile or desktop computer, a personal data assistant (PDA), an internet appliance, an internet enabled mobile phone, a server or any other computing device configured with a network connection.

In some embodiments, in prioritizing the fulfillment of the plural orders for in-store pickup, computing device 104 may prioritize the fulfillment of the plural orders for in-store pickup based at least in part on an estimated arrival time of customer 112, historical actual arrival time, demographic information related to customer 112, and weather conditions. For example, computing device 104 may receive information on traffic conditions for one or more paths between the location of customer 112 and physical store 106, and estimate an arrival time of customer 112 based at least in part on the determined location of customer 112 and the traffic conditions. As for historical actual arrival time, computing device 104 may reference data stored in a database (not shown) that records, for example, actual arrival time of customers who placed an order at approximate the same time of the day and the same day of the week as the order 116 placed by customer 112, historical record of duration between receipt of an order by customer 112 and actual arrival time at physical store 106, etc. Regarding demographic information, computing device 104 may keep a record of demographic information of a number of customers of physical store 106, planned arrival time indicated in orders placed by those customers, and actual arrival time of those customers. Computing device 104 may also receive up-to-date weather information from one or more weather forecast sources to obtain weather conditions of a city or region through which customer 112 needs to travel to arrive at physical store 106.

In some embodiments, computing device 104 may receive an update of the location of the first customer and estimate a revised arrival time of the first customer based at least in part on the update of the location of the first customer. For example, computing device 104 may continuously or periodically track the location of customer 112 on his way to physical store 106 by receiving continuous or periodic location information 117 from user device 118. Computing device 104 may then re-prioritize the fulfillment of the plural orders for in-store pickup based at least in part on the revised arrival time of customer 112.

In some embodiments, in prioritizing the fulfillment of the plural orders for in-store pickup, computing device 104 may determine a prioritized fulfillment queue 122 based at least in part on the estimated arrival time of customer 112 with order 116 disposed at a first position in the prioritized fulfillment queue 122. Computing device 104 may transmit the prioritized fulfillment queue 122 to a computing device 107 associated with physical store 106. In re-prioritizing the fulfillment of the plural orders for in-store pickup, computing device 104 may update the prioritized fulfillment queue 122 based at least in part on the revised estimated arrival time of customer 112 with order 116 disposed at a second position in the prioritized fulfillment queue 122 different than the first position. Computing device 104 may transmit the updated prioritized fulfillment queue 122 to computing device 107 associated with physical store 106. For example, if the revised arrival time of customer 112 indicates that customer 112 is likely to arrive later than the original estimated arrival time, computing device 104 may place order 116 in a later position in a prioritized fulfillment queue 122, since order 116 of customer 112 may not need to be serviced until a later time. Likewise, if the revised arrival time of customer 112 indicates that customer 112 is likely to arrive earlier than the original estimated arrival time, computing device 104 may place order 116 in an earlier position in a prioritized fulfillment queue 122, since order 116 of customer 112 may need to be serviced sooner.

In some embodiments, computing device 104 may receive one or more changes to the plural orders for in-store pickup and predict a number of store associates required to service the plural orders based at least in part on the one or more changes to the plural orders. Computing device 104 may transmit staffing prediction information 124 to computing device 107 associated with physical store 106. For example, customer 112 may decide to cancel order 116 or revise order 116 to pick up one or more additional items. Similarly, one or more other customers may place additional orders or cancel one or more existing orders. As such changes affect the priority for in-store fulfillment, computing device 104 may algorithmically predict, e.g., on a frequent interval, the number of store associates required to service the dynamically changing fulfillment demands. For example, computing device 104 may execute a human resources logistics algorithm to predict the number of store associates required in order to service the plural orders in view of changes to the orders. This feature is aimed to ensure sufficient staffing to service the fulfillment demands as the customers arrive at the physical store 106 to pick up their ordered products and/or services, thereby ensuring high customer satisfaction.

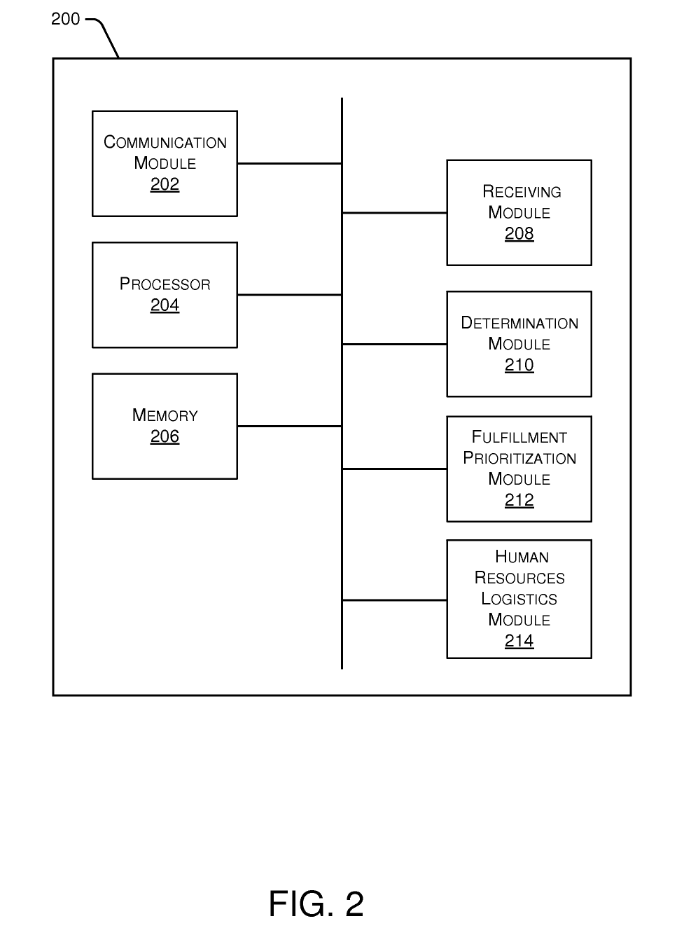

FIG. 2 is a block diagram depicting an embodiment of a computing device 200 configured to implement systems and methods of the present disclosure. Computing device 200 (e.g., computing device 104) performs various functions related to in-store fulfillment prioritization, as discussed herein. In some embodiments, computing device 200 may be implemented as one or more computing devices that cooperatively implement the functions described herein. Computing device 200 may include a communication module 202, one or more processors (shown as a processor 204 in FIG. 2), and a memory 206. Communication module 202 allows computing device 200 to communicate with other systems, such as communication networks, other servers, etc. Processor 204 executes one or more sets of instructions to implement the functionality provided by computing device 200. Memory 206 stores the one or more sets of instructions executable by processor 204 as well as other data used by processor 204. Computing device 200 may also include a receiving module 208, a determination module 210, a fulfillment prioritization module 212, and a human resources logistics module 214. Although the receiving module 208, determination module 210, fulfillment prioritization module 212, and human resources logistics module 214 are depicted as discrete modules separate from the processor 204, in various implementations one or more of the receiving module 208, determination module 210, fulfillment prioritization module 212, and human resources logistics module 214 may be part of the processor 204.

Receiving module 208 may be configured to receive a first order from a first customer for in-store pickup of a first item by the first customer at a store, the first item including a product or a service. For example, receiving module 208 may receive order 116 from user device 118 of customer 112 for in-store pickup of one or more products and/or one or more services at physical store 106.

In some embodiments, receiving module 208 may also be configured to receive information on traffic conditions for one or more paths between the location of the first customer and the store. For example, receiving module 208 may receive information on traffic conditions for one or more paths between the location of customer 112 and physical store 106.

In some embodiments, receiving module 208 may also be configured to receive an update of the location of the first customer. For example, receiving module 208 may receive location information 117 from user device 118 indicating an update of the location of customer 112.

In some embodiments, receiving module 208 may also be configured to receive one or more changes to the plural orders for in-store pickup. For example, receiving module 208 may receive one or more changes to order 116 from user device 118, and may also receive one or more changes to other orders placed by one or more other customers.

Determination module 210 may be configured to determine a location of the first customer. For example, determination module 210 may determine location of customer 112 based on location information 117 received by receiving module 208.

In some embodiments, determination module 210 may also be configured to estimate an arrival time of the first customer based at least in part on the determined location of the first customer and the traffic conditions. For example, upon receiving module 208 receiving information on traffic conditions for one or more paths between the location of customer 112 and physical store 106, determination module 210 may estimate an arrival time of customer 112 based at least in part on the determined location of customer 112 and the traffic conditions.

In some embodiments, determination module 210 may also be configured to estimate a revised arrival time of the first customer based at least in part on the update of the location of the first customer. For example, upon receiving module 208 receiving an update of the location of customer 112, determination module 210 may estimate a revised arrival time of customer 112 based at least in part on the update of the location of customer 112.

Fulfillment prioritization module 212 may be configured to determine a prioritized fulfillment queue for a plural orders for in-store pickup including the first order based at least in part on the location of the first customer. For example, fulfillment prioritization module 212 may generate fulfillment prioritization queue 122 based at least in part on location of customer 112 and location(s) of one or more other customers.

In some embodiments, in determining the prioritized fulfillment queue for the plural orders, fulfillment prioritization module 212 may be configured to determine the prioritized fulfillment queue for the plural orders based at least in part on an estimated arrival time of the first customer, historical actual arrival time, demographic information related to the first customer, and weather conditions.

In some embodiments, fulfillment prioritization module 212 may also be configured to update the prioritized fulfillment queue based at least in part on the revised estimated arrival time of the first customer. For example, upon determination module 210 estimating revised arrival time of customer 112, fulfillment prioritization module 212 may update the prioritized fulfillment queue 122 based at least in part on the revised estimated arrival time of customer 112.

Human resources logistics module 214 may be configured to predict a number of store associates required to service the plural orders for in-store pickup. For example, human resources logistics module 214 may predict a number of store associates required to service the plural orders for in-store pickup and transmit staffing prediction information 124 to computing device 107 of physical store 106.

In some embodiments, human resources logistics module 214 may be configured to revise the predicted number of store associates required to service the plural orders. For example, upon receiving module 208 receiving one or more changes to the plural orders for in-store pickup, human resources logistics module 214 may revise the predicted number of store associates required to service the plural orders based at least in part on the one or more changes to the plural orders.

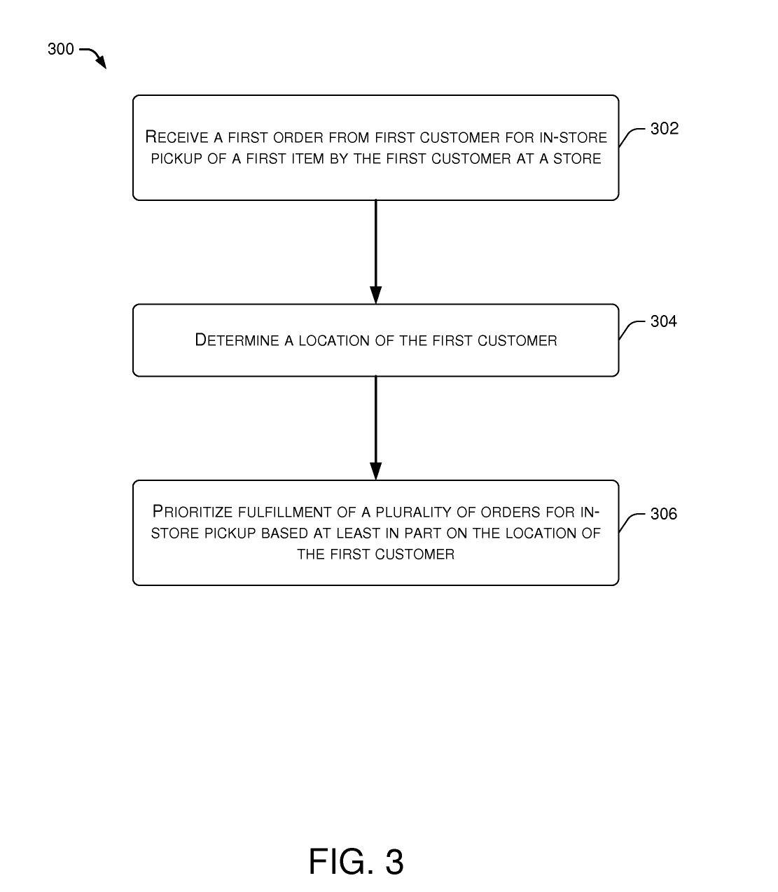

FIG. 3 is a flowchart diagram of an embodiment of a process 300 for in-store fulfillment prioritization based on customer location in accordance with an embodiment of the present disclosure. Example process 300 includes one or more operations, actions, or functions. Although illustrated as discrete blocks, various blocks may be divided into additional blocks, combined into fewer blocks, or eliminated, depending on the desired implementation. Process 300 may be implemented by one or more processors including, for example, computing device 200. For illustrative purposes, the operations described below are performed by one or more processors of computing device 104 as shown in FIG. 1 and/or processor 204 of computing device 200 as shown in FIG. 2.

At 302, one or more processors of computing device 104 may receive a first order from a first customer for in-store pickup of a first item by the first customer at a store. The first item may include a product or a service. For example, computing device 104 may receive order 116 from user device 118 of customer 112 for in-store pickup of a first item by the customer 112 at physical store 106.

At 304, the one or more processors of computing device 104 may determine a location of the first customer.

At 306, the one or more processors of computing device 104 may prioritize fulfillment of a plurality of orders for in-store pickup based at least in part on the location of the first customer. The plurality of orders may include the first order and at least a second order for in-store pickup of a second item.

In some embodiments, in prioritizing the fulfillment of the plurality of orders for in-store pickup, process 300 may prioritize the fulfillment of the plurality of orders for in-store pickup based at least in part on an estimated arrival time of the first customer, historical actual arrival time, demographic information related to the first customer, and weather conditions.

In some embodiments, process 300 may further include: receiving information on traffic conditions for one or more paths between the location of the first customer and the store; and estimating an arrival time of the first customer based at least in part on the determined location of the first customer and the traffic conditions.

In some embodiments, process 300 may further include: receiving an update of the location of the first customer; and estimating a revised arrival time of the first customer based at least in part on the update of the location of the first customer. In some embodiments, process 300 may additionally re-prioritize the fulfillment of the plurality of orders for in-store pickup based at least in part on the revised arrival time of the first customer.

In some embodiments, in prioritizing the fulfillment of the plurality of orders for in-store pickup, process 300 may determine a prioritized fulfillment queue based at least in part on the estimated arrival time of the first customer with the first order disposed at a first position in the prioritized fulfillment queue. Moreover, in re-prioritizing the fulfillment of the plurality of orders for in-store pickup, process 300 may update the prioritized fulfillment queue based at least in part on the revised estimated arrival time of the first customer with the first order disposed at a second position in the prioritized fulfillment queue different than the first position.

In some embodiments, process 300 may further include: receiving one or more changes to the plurality of orders for in-store pickup; and predicting a number of store associates required to service the plurality of orders based at least in part on the one or more changes to the plurality of orders.

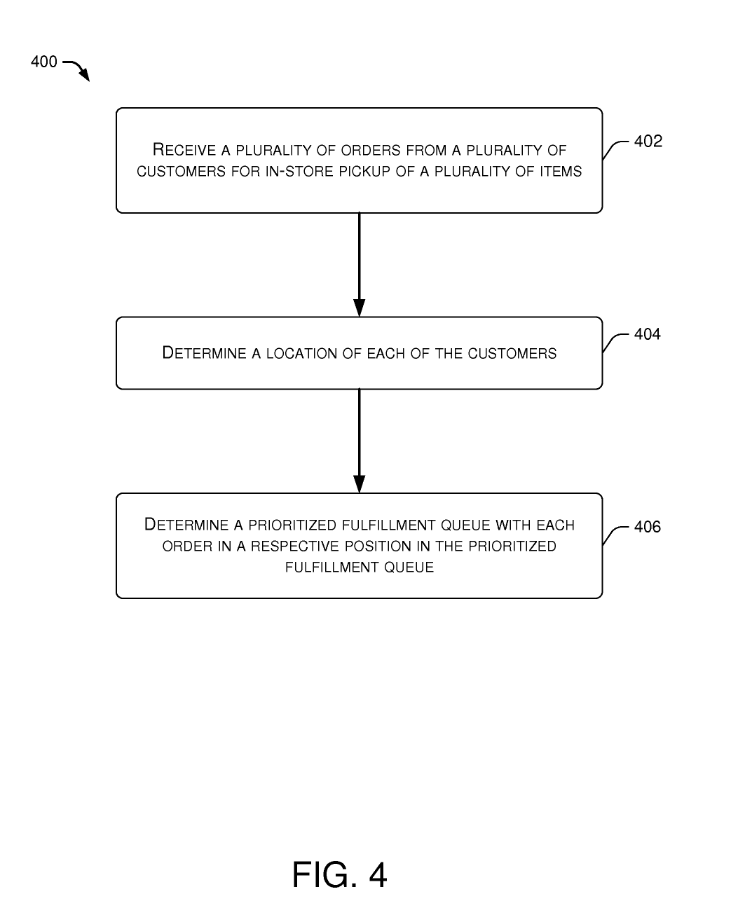

FIG. 4 is a flowchart diagram of an embodiment of a process 400 for in-store fulfillment prioritization based on customer location in accordance with an embodiment of the present disclosure. Example process 400 includes one or more operations, actions, or functions. Although illustrated as discrete blocks, various blocks may be divided into additional blocks, combined into fewer blocks, or eliminated, depending on the desired implementation. Process 400 may be implemented by one or more processors including, for example, computing device 200. For illustrative purposes, the operations described below are performed by one or more processors of computing device 104 as shown in FIG. 1 and/or processor 204 of computing device 200 as shown in FIG. 2.

At 402, one or more processors of computing device 104 may receive a plurality of orders from a plurality of customers for in-store pickup of a plurality of items at a store, each of the plurality of items including a product or a service.

At 404, the one or more processors of computing device 104 may determine a location of each of the plurality of customers.

At 406, the one or more processors of computing device 104 may determine a prioritized fulfillment queue with each order of the plurality of orders in a respective position in the prioritized fulfillment queue.

In some embodiments, in determining the prioritized fulfillment queue, process 400 may determine the prioritized fulfillment queue based at least in part on an estimated arrival time of each customer of the plurality of customers, historical actual arrival time, demographic information related to each customer, and weather conditions.

In some embodiments, process 400 may also include: receiving information on traffic conditions for one or more paths between the location of a first customer of the plurality of customers and the store; and estimating an arrival time of the first customer based at least in part on the determined location of the first customer and the traffic conditions. In some embodiments, process 400 may additionally include: receiving an update of the location of the first customer; and estimating a revised arrival time of the first customer based at least in part on the update of the location of the first customer. In some embodiments, process 400 may further include updating the prioritized fulfillment queue based at least in part on the revised estimated arrival time of the first customer.

In some embodiments, process 400 may further include: receiving one or more changes to the plurality of orders for in-store pickup; and predicting a number of store associates required to service the plurality of orders based at least in part on the one or more changes to the plurality of orders.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method of in-store fulfillment, the method comprising:
receiving, by one or more processors of a computing device, a first order from a first customer for in-store pickup of a first item by the first customer at a store, the first item including a product or a service;
determining, by the one or more processors, a location of the first customer; and
prioritizing, by the one or more processors, fulfillment of a plurality of orders for in-store pickup based at least in part on the location of the first customer, the plurality of orders including the first order and at least a second order for in-store pickup of a second item.

2. The method of claim 1, wherein the prioritizing the fulfillment of the plurality of orders for in-store pickup comprises prioritizing the fulfillment of the plurality of orders for in-store pickup based at least in part on an estimated arrival time of the first customer, historical actual arrival time, demographic information related to the first customer, and weather conditions.

3. The method of claim 1, further comprising:
receiving information on traffic conditions for one or more paths between the location of the first customer and the store; and
estimating an arrival time of the first customer based at least in part on the determined location of the first customer and the traffic conditions.

4. The method of claim 3, further comprising:
receiving an update of the location of the first customer; and
estimating a revised arrival time of the first customer based at least in part on the update of the location of the first customer.

5. The method of claim 4, further comprising:
re-prioritizing the fulfillment of the plurality of orders for in-store pickup based at least in part on the revised arrival time of the first customer.

6. The method of claim 5, wherein the prioritizing the fulfillment of the plurality of orders for in-store pickup comprises determining a prioritized fulfillment queue based at least in part on the estimated arrival time of the first customer with the first order disposed at a first position in the prioritized fulfillment queue, and wherein the re-prioritizing the fulfillment of the plurality of orders for in-store pickup comprises updating the prioritized fulfillment queue based at least in part on the revised estimated arrival time of the first customer with the first order disposed at a second position in the prioritized fulfillment queue different than the first position.

7. The method of claim 1, further comprising:
receiving one or more changes to the plurality of orders for in-store pickup; and
predicting a number of store associates required to service the plurality of orders based at least in part on the one or more changes to the plurality of orders.

8. One or more computer-readable media storing computer-executable instructions that, when executed on one or more processors, causes the one or more processors to perform operations comprising:
receiving a plurality of orders from a plurality of customers for in-store pickup of a plurality of items at a store, each of the plurality of items including a product or a service;
determining a location of each of the plurality of customers; and
determining a prioritized fulfillment queue with each order of the plurality of orders in a respective position in the prioritized fulfillment queue.

9. The one or more computer-readable media of claim 8, wherein the determining the prioritized fulfillment queue comprises determining the prioritized fulfillment queue based at least in part on an estimated arrival time of each customer of the plurality of customers, historical actual arrival time, demographic information related to each customer, and weather conditions.

10. The one or more computer-readable media of claim 8, further comprising:
receiving information on traffic conditions for one or more paths between the location of a first customer of the plurality of customers and the store; and
estimating an arrival time of the first customer based at least in part on the determined location of the first customer and the traffic conditions.

11. The one or more computer-readable media of claim 10, further comprising:
receiving an update of the location of the first customer; and
estimating a revised arrival time of the first customer based at least in part on the update of the location of the first customer.

12. The one or more computer-readable media of claim 11, further comprising:
updating the prioritized fulfillment queue based at least in part on the revised estimated arrival time of the first customer.

13. The one or more computer-readable media of claim 8, further comprising:
receiving one or more changes to the plurality of orders for in-store pickup; and
predicting a number of store associates required to service the plurality of orders based at least in part on the one or more changes to the plurality of orders.

14. An apparatus comprising:
a memory configured to store data and one or more sets of instructions; and
one or more processors coupled to the memory, the one or more processors configured to execute the one or more sets of instructions and perform operations comprising:
receiving a first order from a first customer for in-store pickup of a first item by the first customer at a store, the first item including a product or a service;
determining a location of the first customer; and
determining a prioritized fulfillment queue for a plurality of orders for in-store pickup including the first order based at least in part on the location of the first customer.

15. The apparatus of claim 14, wherein the determining the prioritized fulfillment queue for the plurality of orders comprises determining the prioritized fulfillment queue for the plurality of orders based at least in part on an estimated arrival time of the first customer, historical actual arrival time, demographic information related to the first customer, and weather conditions.

16. The apparatus of claim 14, wherein the one or more processors are configured to further perform operations comprising:
receiving information on traffic conditions for one or more paths between the location of the first customer and the store; and
estimating an arrival time of the first customer based at least in part on the determined location of the first customer and the traffic conditions.

17. The apparatus of claim 16, wherein the one or more processors are configured to further perform operations comprising:
receiving an update of the location of the first customer; and
estimating a revised arrival time of the first customer based at least in part on the update of the location of the first customer.

18. The apparatus of claim 17, wherein the one or more processors are configured to further perform operations comprising:
updating the prioritized fulfillment queue based at least in part on the revised estimated arrival time of the first customer.

19. The apparatus of claim 14, wherein the one or more processors are configured to further perform operations comprising:
predicting a number of store associates required to service the plurality of orders for in-store pickup.

20. The apparatus of claim 19, wherein the one or more processors are configured to further perform operations comprising:
receiving one or more changes to the plurality of orders for in-store pickup; and
revising the predicted number of store associates required to service the plurality of orders based at least in part on the one or more changes to the plurality of orders.
